(19) United States
(12) Patent Application Publication
(10) Pub. No.: US 2010/0150648 A1
(43) Pub. Date: Jun. 17, 2010

(54) QUICK-CONNECT JOINTS AND RELATED METHODS

(76) Inventors: Robert Arnold Judge, Houston, TX (US); Aaron Patrick Smith, Kingwood, TX (US)

Correspondence Address: General Electric Company;GE Global Patent Operation, 2 Corporate Drive, Suite 648, Shelton, CT, 06484, US

(21) Appl. No.: 12/335,139

(22) Filed: Dec. 15, 2008

(51) Int. Cl. F16B 2/14

(52) U.S. Cl. 403/374.1

(57) ABSTRACT

The present disclosure provides a fastener to secure a flange to a main body of a blowout preventer, the fastener including a housing configured to receive a locking pin, a plurality of cavities located within one of the housing or the locking pin, the plurality of cavities each comprising an inclined surface extending from a deep sections of the cavity, a plurality of rollers positioned in the plurality of cavities, and a release cage to retain the plurality of rollers in the plurality of cavities, wherein the release cage moves the plurality of rollers along the inclined surfaces and into compressive engagement between the locking pin and the housing.

### BACKGROUND OF DISCLOSURE

1. Field of the Disclosure

This disclosure relates generally to alternative quick-connect fastener apparatuses and methods for traditional threaded connectors and related methods. More particularly, the disclosure relates to a locking roller mechanism for converting a threaded joint to a quick connect joint.

2. Background Art

The oilfield industry uses a number of different types of equipment to perform processes including, but not limited to, drilling new wells, producing fluids from a wellbore, and refining and distributing the produced fluids. Such equipment may consist of a vast array of individual components that are fastened together to form a final working assembly. A “Christmas tree” is an example of a complex piece of equipment used in the production of a fluid from a well bore. As used in the industry, a Christmas tree is an assembly of valves arranged to control fluids produced from a wellbore by routing them to a desired production string. The numerous valves used in Christmas trees may be attached or connected using flanges with bolt circles providing a strong connection to withstand the pressures that may build up during fluid production.

A ram-type blowout preventer (“BOP”) is another type of equipment used in the oilfield during drilling and production phases. Conventional ram-type blowout preventer designs may include a bonnet door bolted to a face of a body to contain rams and other elements used to seal a wellbore in the event of an emergency. The bonnet doors may be attached to the BOP body by a flange having a bolt circle.

As with any equipment that is operated regularly, oilfield components may require routine maintenance to ensure reliable performance. For example, a Christmas tree may require replacement of the seals used to prevent fluids from leaking from between the valve connections, among other things. Ram-type blowout preventers also may require regular maintenance of their components, such as replacement of the seals, and regular upkeep of the rams to ensure acceptable operation. Such maintenance may require the removal of components from the assembly, and thus the removal of threaded fasteners. Depending on the size of the equipment and the connection, a number of large threaded fasteners may be employed. On a blowout preventer configuration, it may take over an hour per bonnet to effect a ram change-out due to the time required to remove and reinstall the threaded fasteners.

Routine maintenance of equipment as described above is a task that is usually carried out while on the rig. The equipment may be brought to the surface by way of a wireline, worked on, and returned to subsea operation. That said, rig time is a valuable commodity and has a direct correlation to the success and productivity of a well. On the other hand, rig downtime is a quantity that is desirably reduced as much as possible, or avoided altogether. The time taken to facilitate routine maintenance of equipment, for example, a seal replacement of a blowout preventer, may be shortened by the use of a fastener that is removable and installable in less time.

Thus, there is a need in the industry for a device and a method to convert a traditional threaded joint to a quick-connect joint while still maintaining the integrity and reliability of the threaded joint.

### SUMMARY OF INVENTION

In one aspect, embodiments disclosed herein relate to a fastener to secure a flange to a main body of a blowout preventer, the fastener including a housing configured to receive a locking pin, a plurality of cavities located within one of the housing or the locking pin, the plurality of cavities each comprising an inclined surface extending from a deep sections of the cavity, a plurality of rollers positioned in the plurality of cavities, and a release cage to retain the plurality of rollers in the plurality of cavities, wherein the release cage moves the plurality of rollers along the inclined surfaces and into compressive engagement between the locking pin and the housing.

In another aspect, embodiments disclosed herein relate to a method to convert a bolted joint, which is configured to secure a flange to a main body of a blowout preventer, to a quick-connect joint, the method including threading a locking pin into the main body, installing a locking nut on the locking pin to secure the flange to the main body, and moving a plurality of locking rollers within a plurality of cavities of the locking nut with a release cage, such that the plurality of locking rollers are moved into a compressive engagement with a plurality of inclined surfaces of the plurality of cavities and a shaft diameter of the locking pin.

In another aspect, embodiments disclosed herein relate to a method to convert a bolted joint, which is configured to secure a flange to a main body of a blowout preventer, to a quick-connect joint, the method including threading a housing into the main body, inserting a locking pin into the housing to secure the flange to the main body, and moving a plurality of locking rollers within a plurality of cavities of one of the locking pin or the housing with a release cage, such that the plurality of locking rollers are in a compressive engagement with a plurality of inclined surfaces of the plurality of cavities and one of a shaft diameter of the locking pin and an inner bore of the housing.

Other aspects and advantages of the invention will be apparent from the following description and the appended claims.

### BRIEF DESCRIPTION OF DRAWINGS

Embodiments of the present disclosure are discussed with reference to the drawings. Specifically, features of the present disclosure will become more apparent from the following description in conjunction with the accompanying drawings, in which:

FIG. 1A shows a cross-sectional view of a quick-connect fastener in a disengaged position in accordance with embodiments of the present disclosure;

FIG. 1B shows a cross-sectional view of a quick-connect fastener in an engaged position in accordance with embodiments of the present disclosure;

FIG. 2 shows a cross-sectional view of a quick-connect fastener in an engaged position in accordance with embodiments of the present disclosure; and

FIG. 3 shows a cross-sectional view of a quick-connect fastener in an engaged position in accordance with embodiments of the present disclosure.

### DETAILED DESCRIPTION

Embodiments of the present disclosure relate to mechanisms and methods that may be used as alternatives to threaded fasteners to secure adjacent components together. More specifically, embodiments disclosed herein relate to a quick-connect fastener, which includes a plurality of locking rollers that selectively secure (i.e., lock) a pin within a housing and allow the release and removal of the pin from the housing only when desired. In certain instances, the quick-connect fastener may be used to secure a flange to a main body of a blowout preventer.

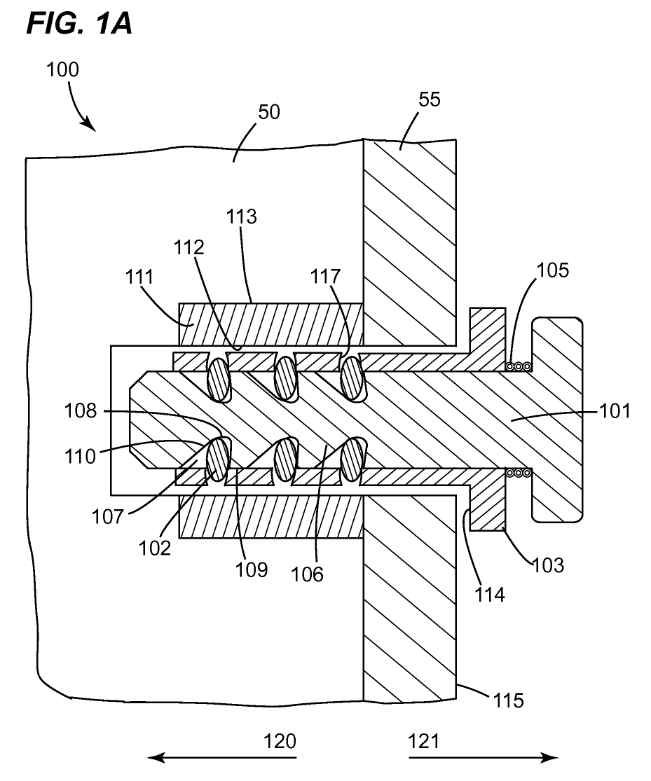

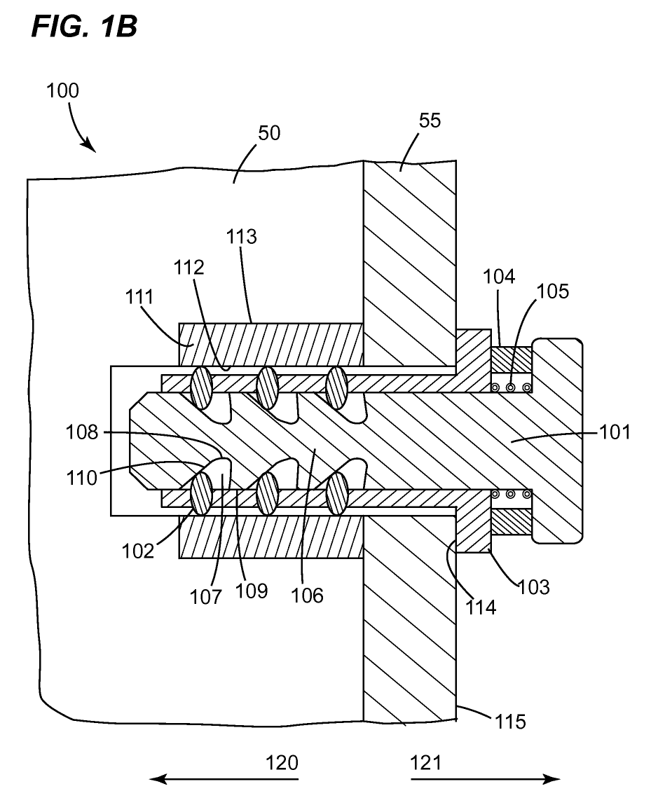

Referring initially to FIGS. 1A and 1B, a quick-connect fastener 100 in accordance with embodiments of the present disclosure is shown. Quick-connect fastener 100 is configured to replace a threaded connector and secure a flange 55 to a main body 50. Quick-connect fastener 100 includes a locking pin 101, one or more locking rollers 102, a release cage 103, a removable clip 104 (i.e., a metal washer or spacer), and a compression spring 105. Quick-connect fastener 100 may be configured to allow displacement of the locking pin 101 in a locking direction 120, while disallowing displacement in an unlocking direction 121. In certain embodiments, a sealing element (not shown) may be disposed between two components which are to be secured to each other (e.g., flange 55 and body 50) to provide a fluid seal therebetween. One of ordinary skill in the art will understand appropriate seal types and sizing of the sealing element.

Locking pin 101 includes a shaft 106 into which one or more roller cavities 107 are formed. Each roller cavity 107 is formed with a deep section 108 that transitions to a shaft outer diameter 109 through an inclined surface 110. Initially, the locking rollers 102 are retained within the deep sections 108 of the cavities 107 by the release cage 103 (as shown in FIG. 1A). The release cage 103 includes openings 117 through which corresponding locking rollers 102 are allowed to protrude. A housing 111 having an internal surface 112 onto which locking rollers 102 engage may be positioned in an existing threaded bolt hole 113 of main body 50 by threading, press-fitting, welding or any other mechanism known to those skilled in the art. In certain embodiment, main body 50 may be a housing of a blowout preventer having a plurality of bolt holes 113 arranged in a “bolt circle” to secure flange 55. Once the locking pin 101 is inserted into the housing 111, movement of the release cage 103 in the locking direction 120 causes the locking rollers 102 to travel along the inclined surfaces 110 and extend through the corresponding openings 117 in the release cage 103. The locking rollers may then engage the internal surface 112 of the housing 111 while also remaining in contact with the inclined surfaces 110 of the locking pin 101 (as shown in FIG. 1B). The release cage 103 may be biased in the locking direction 120 by compression spring 105 so that the locking rollers 102 are also biased in the locking direction 120 and into surface 112 of housing 111.

When pressure from within the main body 50 acts on the flange 55, the inclined surfaces 110 in the locking pin 101 urge the locking rollers 102 to further extend radially outward and engage the internal surface 112 of the housing 111. A compressive engagement of the locking rollers 102 due to contact of the locking rollers 102 with the internal surface 112 and the inclined surfaces 110 provides sufficient friction to prevent movement of the locking pin 101 in the unlocking direction 121, which secures the flange 55 on the main body 50. Removable clip 104 and compression spring 105 may be positioned between the locking pin 101 and the release cage 103 after installation to prevent axial movement of the quick-connect fastener 100. Further, a bearing shoulder 114 of release cage 103 engages the bearing surface 115 of the flange 55 to lock the locking pin 101 in place and secure the flange 55 to the main body 50.

To remove the locking pin 101, removal of clip 104 and movement of the release cage 103 in the unlocking direction 121 will displace the locking rollers 102 from engagement with the surface 112 of the housing 111. Movement of the release cage 103 displaces the locking rollers 102 along the inclined surfaces 110 and allows the locking rollers 102 to retract into the deep sections 108 of the roller cavities 107. The openings 117 in the release cage 103 also prevent the locking rollers 102 from falling out of the roller cavities 107 when the locking pin 101 is not inserted in the housing 111. The openings 117 have slightly smaller diameters than the largest diameter of the locking rollers 102, thus, the locking rollers 102 are unable to fully pass through the openings 117 of the release cage 103.

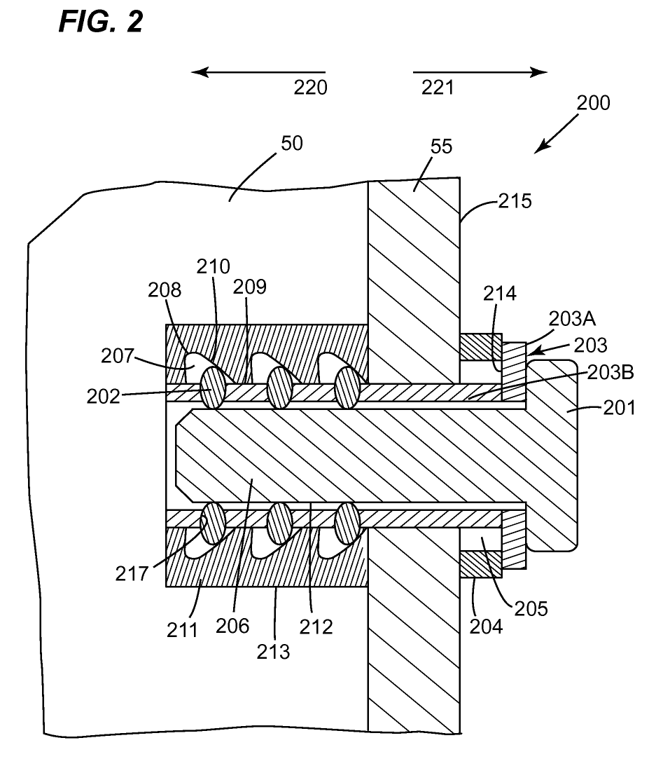

Referring now to FIG. 2, a quick-connect fastener 200 in accordance with an embodiment of the present disclosure is shown. Quick-connect fastener 200 is configured to replace a threaded connector and secure a flange 55 to a main body 50.

Quick-connect fastener 200 includes a locking pin 201, one or more locking rollers 202, a release cage 203, and a removable clip 204 (i.e., a metal washer or spacer). In this embodiment, the release cage 203 includes two separate sections 203A and 203B that may be attached to each other after installing the flange 55 onto the main body 50 and inserting the locking pin 201. Quick-connect fastener 200 may be configured to allow displacement of the locking pin 201 in a locking direction 220, while disallowing displacement of the locking pin 201 in an unlocking direction 221. In certain embodiments, a sealing element (not shown) may be disposed between two components which are to be secured to each other (e.g., flange 55 and body 50) to provide a fluid seal therebetween. One of ordinary skill in the art will understand appropriate seal types and sizing of the sealing element.

The quick-connect fastener 200 is configured differently from quick-connect fastener 100 in that housing 211 has an inner diameter 209 into which roller cavities 207 are formed. A roller cavity 207 is shown having a deep section 208 that transitions to the housing inner diameter 209 through an inclined surface 210. Initially, the locking rollers 202 are retained within the deep sections 208 of the cavities 207 by the release cage 203.

The release cage 203 includes openings 217 through which corresponding locking rollers 202 are allowed to protrude. Movement of the release cage 203 in locking direction 221 causes the locking rollers 202 to travel along the inclined surfaces 210 and extend through the corresponding openings 217 in the release cage 203. The locking rollers may then engage an outer shaft diameter 212 of the locking pin 201 while also remaining in contact with the inclined surfaces 210 of the housing 211.

When pressure from within the main body 50 acts on the flange 55, the inclined surfaces 110 in the locking pin 201 urge the locking rollers 202 to further extend radially inward and engage the shaft diameter 212 of the locking pin 201. A compressive engagement of locking rollers 202 due to contact of the locking rollers 202 with the shaft diameter 212 and the inclined surfaces 210 provides sufficient friction to prevent movement of the locking pin 201 in the unlocking direction 221, which secures the flange 55 on the main body 50. The removable clip 204 may be positioned to prevent axial movement between the locking pin 201 and the release cage 203 after installation of the quick-connect fastener 200. Further, a bearing shoulder 214 of release cage 203 engages the bearing surface 215 of the flange 55 through the clip 204 to lock the locking pin 201 in place and secure the flange 55 to the main body 50.

To remove the locking pin 201, removal of clip 204 and movement of the release cage 203 in direction 220 will displace the locking rollers 202 from engagement with the surface 212 of the housing 211. Movement of the release cage 203 displaces the locking rollers 202 along the inclined surfaces 210 and allows the locking rollers 202 to retract into the deep sections 208 of the roller cavities 207. The openings 217 in the release cage 203 have slightly smaller diameters than a diameter of the locking rollers 202, and thus prevent the locking rollers 202 from falling out of the roller cavities 207 when the locking pin 201 is not inserted in the housing 211.

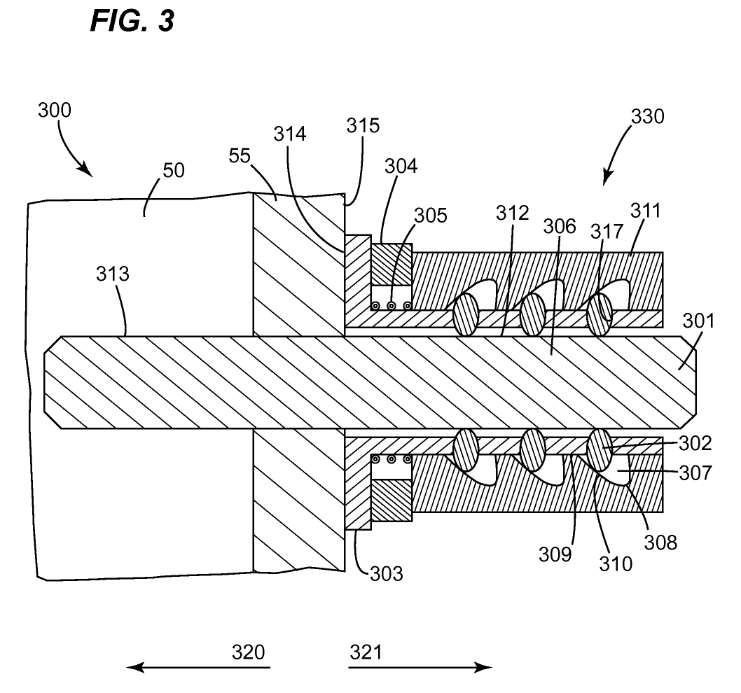

Referring now to FIG. 3, a quick-connect fastener system 300 in accordance with an embodiment of the present disclosure is shown. Quick-connect fastener 300 is configured to replace a threaded connector and secure a flange 55 to a main body 50.

Quick-connect fastener system 300 is configured differently from quick-connect fasteners 100, 200 in that quick-connect fastener 300 includes a locking pin 301 and a locking nut 330. Locking nut 330 includes one or more locking rollers 302, a release cage 303, a removable clip 304 (i.e., a metal washer or spacer), and a compression spring 305.

Quick-connect fastener 300 may be configured to allow displacement of locking nut 330 in a locking direction 320 while disallowing displacement of locking nut 330 in an unlocking direction 321. Locking nut 330 further includes a housing 311 with an inner diameter 309 into which roller cavities 307 are formed. Each roller cavity 307 is shown including a deep section 308 that transitions to the housing inner diameter 309 through an inclined surface 3 10.

Locking pin 301 comprises a shaft 306 with a shaft diameter 312 onto which locking rollers 302 are allowed to engage. Locking pin 301 may include a threaded connection 313 which may be inserted into an existing threaded bolt hole of main body 50. While locking pin 301 is described as having external threads 313 compatible with an existing threaded bolt hole, it should be understood that other connection mechanisms may be used. For example, locking pin 301 may be welded, press-fit, brazed, threaded, or otherwise held in place by other methods known to one of ordinary skill in the art.

Initially, the locking rollers 302 are retained within the deep sections 308 of the cavities 307 by the release cage 303. The release cage 303 includes openings 317 through which corresponding locking rollers 302 are allowed to protrude. Movement of the release cage 303 in direction 320 causes the locking rollers 302 to travel along the inclined surfaces 310 and extend through the corresponding openings 317 in the release cage 303. The locking rollers may then engage the shaft diameter 312 of the locking pin 301 while also remaining in contact with the inclined surfaces 310 of the housing 311.

When pressure from within the main body 50 acts on the flange 55, the inclined surfaces 310 in the locking pin 301 urge the locking rollers 302 to further extend radially inward and engage the shaft diameter 312 of the locking pin 301. A compressive engagement of locking rollers 302 due to contact of the locking rollers 302 with the shaft diameter 312 and the inclined surfaces 310 provides sufficient friction to prevent movement of the locking nut 330 in the unlocking direction 321, which secures the flange 55 on the main body 50. The removable clip 304 and compression spring 305 may be positioned to prevent axial movement between the housing 311 and the release cage 303 after installation of the locking nut 330. Further, a bearing shoulder 314 of release cage 303 engages the bearing surface 315 of the flange 55 to lock the locking pin 301 in place and secure the flange 55 to the main body 50.

To remove the locking nut 330, removal of clip 304 and movement of the release cage 303 in direction 321 will displace the locking rollers 302 out of engagement with the shaft diameter 312 of the locking pin 301. Movement of the release cage 303 displaces the locking rollers 302 along the inclined surfaces 310 and allows the locking rollers 302 to retract into the deep sections 308 of the roller cavities 307. The openings in the release cage 303 also prevent the locking rollers 302 from falling out of the roller cavities 307 when the locking nut 330 is not installed over the locking pin 301. The openings 317 have slightly smaller diameters than the largest diameter of the locking rollers 302, thus, the locking rollers 302 are unable to fully pass through the openings 317 of the release cage 303.

In certain embodiments, a tensioning device may be used with the quick-connect fasteners 100, 200 to induce a specified “pre-load” on the locking pin prior to allowing any pressure to be exerted on the flange from the main body. The pre-load may urge the locking rollers into compressive engagement between engaged surfaces, thus preventing any initial “slippage” or movement of the connection once working pressure is applied to the connection. Further, the tensioning device may be used to induce a specified pre-load on the locking pin of quick-connect fastener 300 before the locking nut is installed. Thus, the locking pin is stretched a specified amount prior to any working pressure being applied to the connection.

It should be understood that inclined surfaces 110, 210, 310 may be any of various types known in the art. Particularly, inclined surfaces 110, 210, 310 may be a planar surface or may be profiled or curved to fit the contours of locking rollers 102, 202, 302. Additionally, it should be understood that deep sections 108, 208, 308 may be constructed to have a profile and depth capable of receiving rollers 102, 202, 302 deeply enough such that locking pins 101, 201, 301 may be removed from housings 111, 211, 311 without the rollers binding therebetween.

Furthermore, while rollers 102, 202, 302 are described generically, it should be understood that they may have a spherical, cylindrical, tapered, elliptical or any other geometry known to one of ordinary skill in the art. Furthermore, rollers 102, 202, 302 may be constructed with various hardness, friction, and wear resistance properties to facilitate contact and engagement between locking pins 101, 201, 301 and shaft diameters 112, 212, 312.

Embodiments disclosed herein may be used to convert a bolted joint, which is configured to secure a flange to a main body of a blowout preventer, to a quick-connect joint. In certain instances, the method involves threading the locking pin into the main body, and then installing the locking nut on the locking pin to secure the flange to the main body. To lock the quick-connect joint, the plurality of locking rollers within the plurality of cavities of the locking nut are moved with the release cage, such that the plurality of locking rollers are moved into a compressive engagement with the plurality of inclined surfaces of the plurality of cavities and the shaft diameter of the locking pin.

In another configuration of the quick-connect joint, the method may involve threading the housing into the main body and then inserting the locking pin into the housing to secure the flange to the main body. Again, to lock the quick-connect joint, the plurality of locking rollers within the plurality of cavities of one of the locking pin or the housing are moved with the release cage, such that the plurality of locking rollers are in a compressive engagement with the plurality of inclined surfaces of the plurality of cavities and one of a shaft diameter of the locking pin and an inner bore of the housing.

Quick-connect fasteners 100, 200, 300 of the present disclosure exhibit many advantages over threaded fasteners currently available as well as conventional quick-connect fasteners. In particular, quick-connect fasteners 100, 200, 300 may be capable of converting a threaded (or other type) joint to a quick-connect joint in a very short time, while still providing the same joint integrity and reliability as the replaced threaded fasteners. The less time that is required for removing or installing fasteners between components of, for example, a blowout preventer, may lead to increased efficiency and cost savings. Embodiments disclosed herein may provide a fastener which may be removed and installed in much less time than a threaded fastener.

Further, quick-connect fasteners 100, 200, 300 may be functional when a connection requires a sealed joint. Seals used in these connections may include radial seals as well as face seals requiring a slight preload. In certain applications, extremely high pressures may be experienced between components, and therefore, a reliable and strong fastener is required. Embodiments disclosed herein provide a structurally sound fastener capable of withstanding such extreme environments as may be encountered in the industry.

Finally, quick-connect fasteners 100, 200, 300 may convert a threaded connection to a quick-connection without requiring modification of the structures to be joined. Previously, in order to modify a connection system, the components to be secured may have been required to be machined or shaped prior to connection. Embodiments of the present disclosure immediately adapt to the components and are able to secure the components without the need for significant modifications.

While the disclosure has been described with respect to a limited number of embodiments, those skilled in the art, having benefit of this disclosure, will appreciate that other embodiments can be devised which do not depart from the scope of the embodiments as disclosed herein. Accordingly, the scope of the disclosure should be limited only by the attached claims.

What is claimed is:

1. A fastener to secure a flange to a main body of a blowout preventer, the fastener comprising:
a housing configured to receive a locking pin;
a plurality of cavities located within one of the housing or the locking pin, the plurality of cavities each comprising an inclined surface extending from a deep sections of the cavity;
a plurality of rollers positioned in the plurality of cavities; and
a release cage to retain the plurality of rollers in the plurality of cavities;
wherein the release cage moves the plurality of rollers along the inclined surfaces and into compressive engagement between the locking pin and the housing.

2. The fastener of claim 1, further comprising a spring configured to bias the plurality of rollers into compressive engagement through the release cage.

3. The fastener of claim 1, further comprising a locking clip to prevent displacement of the release cage in a direction that would release the plurality of rollers from compressive engagement between the locking pin and the housing.

4. The fastener of claim 1, wherein the housing is configured to be threadably secured to the main body of the blowout preventer.

5. The fastener of claim 1, wherein the locking pin is configured to be threadably secured to the main body of the blowout preventer.

6. The fastener of claim 1, wherein the rollers are selected from the group comprising spherical rollers, cylindrical rollers, tapered rollers, and elliptical rollers.

7. The fastener of claim 1, wherein the inclined surfaces comprise planar surfaces.

8. The fastener of claim 1, wherein the inclined surfaces comprise contoured surfaces.

9. The fastener of claim 1, further comprising a tensioning device to apply a pre-load to the connection to induce a specified strain on the locking pin prior to applying a working pressure to the connection.

10. The fastener of claim 9, wherein the release cage is moved to a locked position after the locking pin is stretched to the specified strain.

11. The fastener of claim 1, further comprising a sealing element between the first component and the second component.

12. A method to convert a bolted joint, which is configured to secure a flange to a main body of a blowout preventer, to a quick-connect joint, the method comprising:
threading a locking pin into the main body;
installing a locking nut on the locking pin to secure the flange to the main body;
moving a plurality of locking rollers within a plurality of cavities of the locking nut with a release cage, such that the plurality of locking rollers are moved into a compressive engagement with a plurality of inclined surfaces of the plurality of cavities and a shaft diameter of the locking pin.

13. The method of claim 12, wherein the cavities comprise an inclined surface extending from a deep section.

14. The method of claim 12, further comprising providing a seal between the flange and the main body.

15. A method to convert a bolted joint, which is configured to secure a flange to a main body of a blowout preventer, to a quick-connect joint, the method comprising:
threading a housing into the main body;
inserting a locking pin into the housing to secure the flange to the main body;
moving a plurality of locking rollers within a plurality of cavities of one of the locking pin or the housing with a release cage, such that the plurality of locking rollers are in a compressive engagement with a plurality of inclined surfaces of the plurality of cavities and one of a shaft diameter of the locking pin and an inner bore of the housing.

16. The method of claim 15, further comprising thrusting the rollers in an unlocking direction to release the locking pin from the housing.

17. The method of claim 15, wherein the cavities comprise an inclined surface extending from a deep section.

18. The method of claim 15, further comprising providing a seal between the flange and the main body.

19. The method of claim 15, wherein the rollers are selected from the group comprising spherical rollers, cylindrical rollers, tapered rollers, and elliptical rollers.

20. The method of claim 15, wherein the inclined surfaces comprise planar surfaces.
